(19) United States
(12) Patent Application Publication
(10) Pub. No.: US 2005/0117766 A1
(43) Pub. Date: Jun. 2, 2005

(54) Speaker unit for seat

(75) Inventors: Takeshi Ito, Yamagata (JP); Tetsuya Onuma, Yamagata (JP); Koji Maekawa, Yamagata (JP); Toshihiro Tanno, Yamagata (JP)

Correspondence Address: NIXON & VANDERHYE, PC, 1100 N GLEBE ROAD, 8TH FLOOR, ARLINGTON, VA, 22201-4714, US

(73) Assignees: Pioneer Corporation, Tokyo (JP); Tohoku Pioneer Corporation, Yamagata (JP)

(21) Appl. No.: 10/992,095

(22) Filed: Nov. 19, 2004

(30) Foreign Application Priority Data
Nov. 20, 2003 (JP) 2003-390599

(51) Int. Cl. H04B 1/00; H04R 1/02; H04R 5/02

(52) U.S. Cl. 381/333; 381/301; 381/388

(57) ABSTRACT

A speaker unit in which an open end of each of acoustic tubes is disposed on an upper surface of a casing is produced. The speaker unit is mounted inside a seat, for example, to an upper position of an inside of a backrest of the seat via a connecting member or the like. Thereby, the open ends of the acoustic tubes are disposed at a position near both ears of a seated person. Since low-frequency sound can be reproduced to an area near both the ears of the seated person, so much output sound pressure level of the drive speaker is not needed. Therefore, a drive speaker of a small bore diameter can be applied to the speaker unit, and the speaker unit itself can be made compact and light. The speaker unit is mounted inside the backrest of the seat, for example, and it is not necessary to take the trouble to ensure a place for placing the speaker unit around the seat. Accordingly, for example, when the speaker unit is mounted inside the seat of a vehicle, a narrow space inside the vehicle can be utilized effectively.

### BACKGROUND OF THE INVENTION

1. Field of the Invention

The present invention relates to a speaker unit for reproducing low-frequency sound, particularly mounted inside a seat of a vehicle or the like.

2. Description of Related Art

As a speaker unit for reproducing low-frequency sound, phase inversion type speaker units such as a bass-reflex type and a Kelton type are conventionally known.

For example, a bass-reflex type speaker unit includes a casing having a cavity inside, a so-called enclosure, a speaker for reproducing low-frequency sound provided on one side surface of the enclosure, and a duct provided on the same side surface. This duct is formed into a cylindrical shape, and connects an inside of the enclosure and an outside of the enclosure. At the time of reproducing sound, such a speaker unit inverts the phase of an acoustic wave emitted from a rear surface of a speaker diaphragm, and emits the acoustic wave to the outside of the enclosure via the duct. Thereby, the speaker unit intensifies the acoustic wave emitted to a front surface from the speaker diaphragm to make it possible to reproduce low-frequency sound.

As a speaker unit of this kind, there is proposed, for example, a speaker unit for reproducing low-frequency band sound in which distortion is reduced by making the phase characteristic flat in an actual use band and the sound image localization in a low-frequency band is improved (for example, refer to Japanese Patent Application Laid-Open under No. 2002-159083). There is also proposed a sub woofer box device which makes it possible to reproduce low heavy sound by relieving increase and decrease of pressure caused when a chamber has an enclosed structure, and further reduces the generation of abnormal sound (for example, refer to Japanese Patent Application Laid-Open under No. 9-275595).

There is proposed a sub woofer level adjustment device that can accurately adjust a level of a sub woofer (for example, refer to Japanese Patent Application Laid-Open under No. 2002-186087).

The aforementioned speaker units are frequently loaded especially on a vehicle and the like. The speaker units are usually placed in appropriate positions inside a vehicle, for example, in a vacant space in a rear part, a periphery of a seat or the like inside the vehicle. As a result, the speaker unit is installed in a position away from the ears of a seated person in the vehicle. Accordingly, such speaker unit needs to emit sufficient low-frequency sound to the ears of the seated person in the vehicle, and therefore a speaker with large output power is used.

However, since such a powerful speaker has a large bore diameter and a heavy magnetic circuit, the speaker unit itself has a large shape and is heavy. Therefore, there arises the problem that the speaker unit occupies a narrow space in a vehicle.

### SUMMARY OF THE INVENTION

As the problems to be solved by the present invention, those described above are cited as examples. The present invention has its object to provide a compact and light speaker unit for reproducing low-frequency sound, which is capable of being mounted inside a seat.

According to one aspect of the present invention, there is provided a speaker unit for a seat, including a speaker device including a pair of acoustic tubes, and a casing which houses at least a part of the speaker device and is housed inside a seat, and wherein one end of each of the acoustic tubes is opened to an outside in a sound emitting surface of the casing which becomes a top surface and is exposed to the outside of the seat when the casing is housed inside the seat.

According to the above-described speaker unit, at least a part of the speaker device for reproducing low-frequency sound, which includes a pair of acoustic tubes capable of reproducing low-frequency sound, for example, is housed in the casing, and the casing is housed inside the seat of a vehicle or the like. In this case, the end portions of a pair of acoustic tubes are opened to the outside in the sound emitting surface of the casing, which becomes the top surface and is exposed to the outside of the seat when the casing is housed inside the seat. More preferably, each end portion of the pair of acoustic tubes is located in the vicinity of left and right ears of the seated person in the seat. Therefore, low-frequency sound can be reproduced to the area in the vicinity of both the ears of the seated person, at the time of driving the speaker unit.

Since the low-frequency sound can be reproduced to the area in the vicinity of both the ears of the seated person, the output sound pressure level of the speaker device is not needed so much. Therefore, a compact speaker device with a small bore diameter can be applied to the speaker unit, and the speaker unit itself can be made compact and light. Thereby, the shape or the like of the acoustic tube can be freely changed, and therefore it is possible to design a compact and light speaker unit. In this speaker unit, the lowest resonance frequency can be easily set by changing the length, the sectional area and the like of the acoustic tubes.

In one feature of the above-described speaker unit for the seat, the casing can house a whole of the speaker device. Thereby, the speaker unit can be completely contained inside the seat.

In another feature of the above-described speaker unit for the seat, the casing houses only the acoustic tubes, and the speaker device further includes external units each including an acoustic capacity portion and a drive speaker. The external units are detachably attached to the other ends of the acoustic tubes housed inside the casing at a position of an outside of the seat. Thereby, only the external unit including the acoustic capacity portion and the drive speaker device can be replaced afterwards.

In still another feature of the above-described speaker unit for the seat, the casing houses only the acoustic tubes, and the speaker device further includes external units each having an external acoustic tube, an acoustic capacity portion and a drive speaker. The external units are detachably attached to the other ends of the acoustic tubes housed inside the casing at a position of an outside of the seat. Thereby, only the external unit including the external acoustic tube, the acoustic capacity portion and the drive speaker can be replaced afterwards. Especially, it is possible to change the lowest resonance frequency of the speaker device and change the frequency of the reproduced sound by attaching the external acoustic tubes of different lengths.

In yet another feature of the above-described speaker unit for the seat, it is preferable that end portions of the pair of acoustic tubes opened to the outside are separated by a distance approximately equal to a distance between both ears of an average human being in a sound emitting surface of the casing. Thereby, the end portions of a pair of acoustic tubes can be properly located at the ears of the seated person when the speaker unit is mounted to the seat.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a perspective view of a construction of a speaker unit of a first embodiment;

FIG. 2 is a block diagram showing a method of supplying electric power and an audio signal to the speaker unit of the present invention;

FIG. 3 is a diagram explaining a Helmholtz resonance frequency and a resonance frequency of an acoustic tube by the speaker unit of the present invention;

FIG. 4 is a view schematically showing another example of the speaker unit of the first embodiment;

FIG. 5 is a side view of a state in which the speaker unit is mounted inside a front seat of a vehicle;

FIG. 6 is a plan view of a state in which the speaker units are mounted inside the front seats of the vehicle;

FIG. 7 is a rear view of a state in which the speaker unit is mounted inside the front seat of the vehicle;

FIGS. 8A and 8B are views schematically showing constructions of speaker units of a second embodiment of the present invention;

FIGS. 9A and 9B are rear views showing a state in which the speaker units of the second embodiment are mounted inside the seats of the vehicle;

FIG. 10 is a side view of a state in which the speaker unit is mounted inside a backrest of a chair for a personal computer; and

FIG. 11 is a rear view of a state in which the speaker units are mounted inside the backrests of the chairs in a beauty parlor.

### DETAILED DESCRIPTION OF THE PREFERRED EMBODIMENTS

The preferred embodiments of the present invention will now be described below with reference to the attached drawings.

The embodiments provide a compact and light speaker unit for reproducing low-frequency sound, which is capable of being mounted inside a seat.

### 1st Embodiment

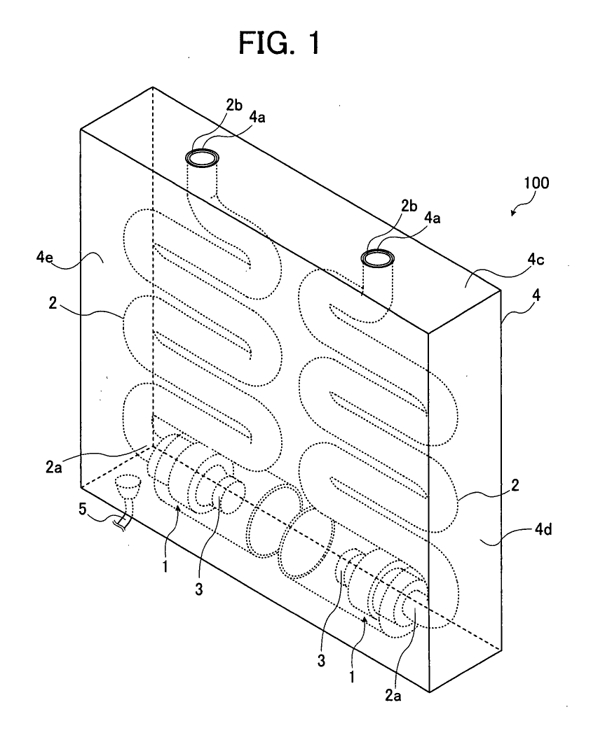

FIG. 1 schematically shows a construction of a speaker 100 according to a first embodiment of the present invention. FIG. 1 shows a perspective view of the speaker unit 100. Hereinafter, the construction of the speaker 100 according to the first embodiment of the present invention will be explained with reference to FIG. 1.

The speaker 100 includes an acoustic capacity portion 1, an acoustic tube 2, a drive speaker 3, wiring 5 and a casing 4 having a space inside. A speaker device for reproducing low-frequency sound is constructed by the acoustic capacity portion 1, the acoustic tube 2 and the drive speaker 3. The speaker 100 is mounted inside various kinds of seats (including various kinds of chairs, the same thing will apply hereinafter) and used, as will be described later.

The acoustic capacity portion 1 is connected to an open end 2a of the acoustic tube 2 and a sound emitting side of the drive speaker 3, respectively.

The acoustic tube 2 has two open ends 2a and 2b. The one open end 2a is connected to the acoustic capacity portion 1 as described above, and the other open end 2b is connected to an upper surface 4c of the casing 4. A distance between the two open ends 2b on the upper surface 4c of the casing 4 is desired to be about the distance between both ears of an average human being, and it can be set at about 10 to 20 cm, for example. The acoustic tube 2 is formed into the curved shape to correspond to the size of the seat which will be described later and to emit low-frequency sound in a predetermined band, but the acoustic tube 2 is not limited to such a shape. Accordingly, the acoustic tube 2 can be formed into various kinds of shapes such as a U-shape and a linear shape as necessary.

The drive speaker 3 is preferably a compact and light speaker suitable for reproducing low-frequency sound. The wiring 5 is a wiring for supplying electric power and audio signals to the drive speaker 3 from a sound source which will be described later, or the like. The wiring 5 is connected to a voice coil (not shown) of the drive speaker 3.

The casing 4 is provided with openings 4a. A plurality of openings 4a are formed on the upper surface 4c of the casing 4, and the position of each of the openings 4a corresponds to the position of the open end 2b of each of the acoustic tubes 2.

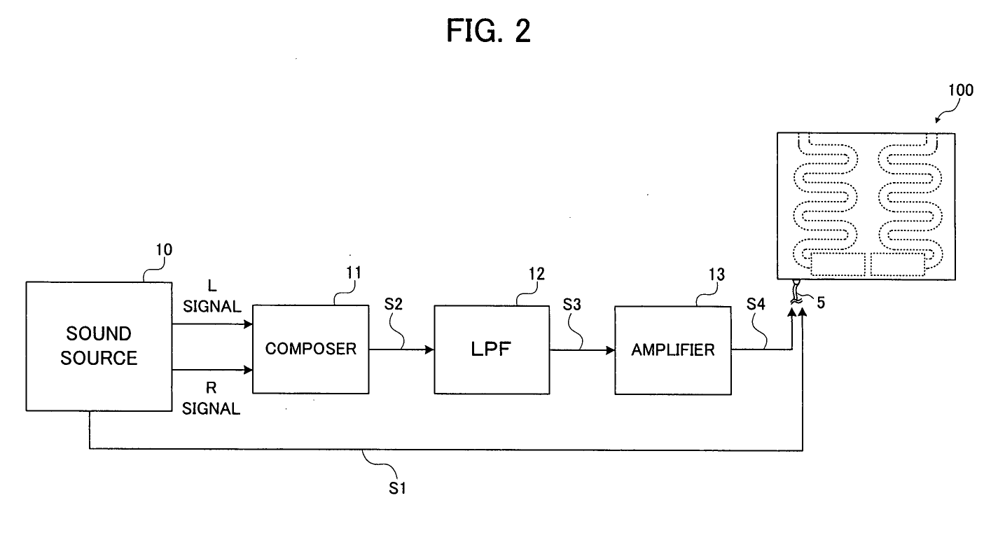

Next, with reference to FIG. 2, a method for supplying electric power and audio signals to the speaker 100 will be briefly described.

The electric power supply to the speaker 100 is performed through a sound source 10 as shown by the allow S1, for example. More specifically, the sound source 10 outputs electric power of a predetermined magnitude to the drive speaker 3 through the wiring 5 (signal S1). Thereby, electric power supply to the speaker 100 is performed. Meanwhile, supply of the audio signals to the speaker 100 is performed through the sound source 10, a composer 11, an LPF (Low Pass Filter) 12, and an amplifier 13.

The sound source 10 corresponds to a CD (Compact Disc) player, an MD (Mini Disc) player or the like. The sound source 10 outputs left-right dual channel audio signals L and R to the composer 11. The composer 11 adds up the outputted L and R audio signals, and outputs the added (L+R) audio signal to the LPF 12 (signal S2). The LPF 12 cuts off a predetermined frequency component. More specifically, the LPF 12 extracts only an audio signal of a predetermined low frequency from the (L+R) audio signal outputted through the composer 11, and outputs the extracted audio signal to the amplifier 13 (signal S3). The amplifier 13 amplifies the extracted audio signal by a predetermined amplification factor, and outputs the amplified audio signal to the drive speaker 3 via the wiring 5 (signal S4). On receiving the supply of electric power and the audio signal through the sound source 10 or the like in this manner, the drive speaker 3 emits a low frequency-band acoustic wave to the acoustic capacity portion 1 through the diaphragm (not shown).

In this speaker unit 100, the acoustic capacity portion 1 and the acoustic tube 2 constitute a resonator of Helmholtz. As a result, the speaker 100 produces resonance at two resonance frequencies, i.e., the resonance frequency as the Helmholtz resonator by the acoustic capacity portion 1 and the acoustic tube 2, and the resonance frequency by the acoustic tube 2 itself.

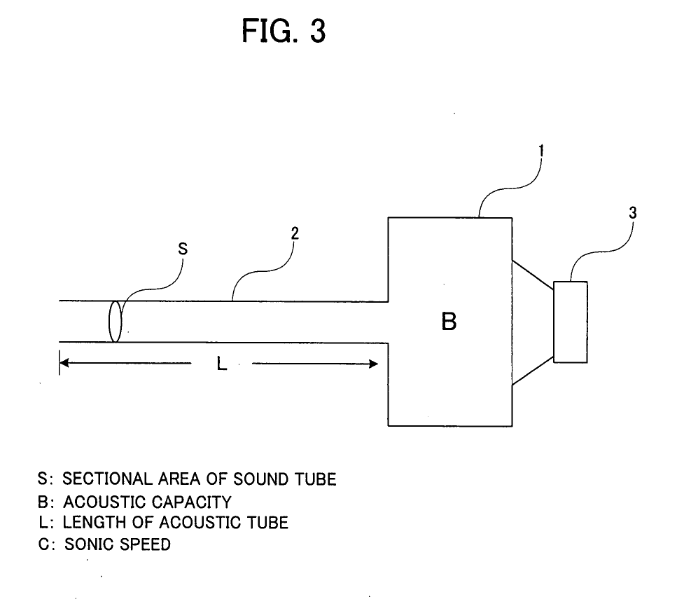

Here, FIG. 3 schematically shows the construction of the structure constituted of the acoustic capacity portion 1, the acoustic tube 2 and the drive speaker 3 which are housed in the speaker unit 100. In FIG. 3, the acoustic tube 2 in the curved shape is formed in the linear shape for convenience of explanation. When the length of the linearly shaped acoustic tube 2 is expressed as “L”, the sectional area of the acoustic tube 2 is expressed as “S”, the acoustic capacity of the acoustic capacity portion 1 is expressed as “B”, and the sonic speed is expressed as “C”, the Helmholtz resonance frequency “f0” and the resonance frequency “f” of the acoustic tube 2 by the speaker 100 are respectively obtained as follows.

Helmholtz Resonance frequency

$$f ∘ = \frac{C}{2 π} \sqrt{\frac{S}{LB}}$$

Resonance frequency of a tube with both end opened

$$f = \frac{C}{2 L}$$

Resonance frequency of a tube with one end opened

$$f = \frac{C}{4 L}$$

It is noted that the resonance frequency of the acoustic tube 2 differs in the case that both ends of the acoustic tube 2 are opened and in the case that one end is opened.

When the air inside the acoustic capacity B is vibrated by the drive speaker 3, sound is emitted with the highest sound pressure from the open end 2b of the acoustic tube 2 at the Helmholtz resonance frequency, namely, the resonance frequency of the compliance of the acoustic capacity B and the air mass inside the acoustic tube 2. Since the acoustic capacity B exists at the right side of the acoustic tube 2 as shown in FIG. 3, the resonance frequency of the acoustic tube 2 occurs between the frequency in the case that both the ends are opened and the frequency in the case that one end is opened. In this case, sound is emitted from the open end 2b of the acoustic tube 2 at a predetermined higher frequency than the above-descried Helmholtz resonance frequency.

As a result, a frequency with a high sound pressure level can be obtained in a predetermined low-frequency sound range, for example, in the range of the lowest resonance frequency of, for example, 300 Hz or lower by the resonance of Helmholtz by the acoustic capacity portion 1 and the acoustic tube 2 and the resonance by the acoustic tube 2 itself, and hence the speaker 100 can be utilized as the speaker device for low-frequency sound. The lowest resonance frequency can be set at a predetermined value by setting the sectional area S and the length L of the acoustic tube 2, and the acoustic capacity B of the acoustic capacity portion 1 to an appropriate area, capacity and length, respectively as necessary.

In the above-described embodiment, in order to reproduce low-frequency sound of a suitable sound volume for the left and right ears of a seated person, a pair of structures each constructed by the acoustic capacity portion 1, the acoustic tube 2 and the drive speaker 3 are housed in the casing 4 to form the speaker device for reproducing low-frequency sound. However, the speaker device of the invention is not limited to this, and it is possible to properly change the number of structures housed in the casing 4 as necessary.

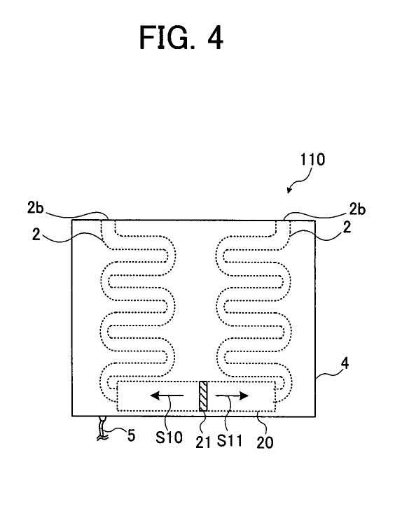

For example, as another example of the first embodiment, a speaker unit for reproducing low-frequency sound provided with only one acoustic capacity portion and one drive speaker in the casing 4 can be constructed without changing the length, the sectional area, the shape and the placement of the acoustic tube 2. FIG. 4 schematically shows the construction of such a speaker unit 110.

The speaker unit 110 is provided with only one drive speaker 21 inside an acoustic capacity portion 20 as shown in FIG. 4. When electric power and an audio signal are supplied to the drive speaker 21 from the sound source 10 through the wiring 5 in the speaker unit 110 of this example, a diaphragm (not shown) of the drive speaker 21 vibrates in a major axis direction of the acoustic capacity portion 20, and low frequency-band acoustic waves are emitted from a front surface direction (the arrow S10) and a rear surface direction (the arrow S11) of the drive speaker 21 by the diaphragm, respectively. These acoustic waves are emitted to an outside through the acoustic capacity portion 20 and the open end 2b of each of the acoustic tubes 2, and low-frequency sound is reproduced by the speaker unit 110.

Incidentally, the speaker unit 110 is provided with only one drive speaker 21. Therefore, there is the possibility that a low-frequency sound with desired sound pressure is not reproduced sufficiently depending on the specified output sound pressure of the drive speaker 21. Accordingly, in order to reproduce a desired low-frequency sound sufficiently, it is preferable to apply, to the speaker unit 110, a speaker with a larger bore diameter of the diaphragm than in the aforesaid drive speaker 3, for example.

Next, a method for mounting the speaker unit to a seat will be described. The speaker unit of the present invention is used in the state in which it is mounted inside various kinds of seats of a vehicle, a personal computer, a beauty parlor and the like. Mounting of the speaker units of the present invention to the inside of various kinds of seats is basically performed by seat manufacturers or the like.

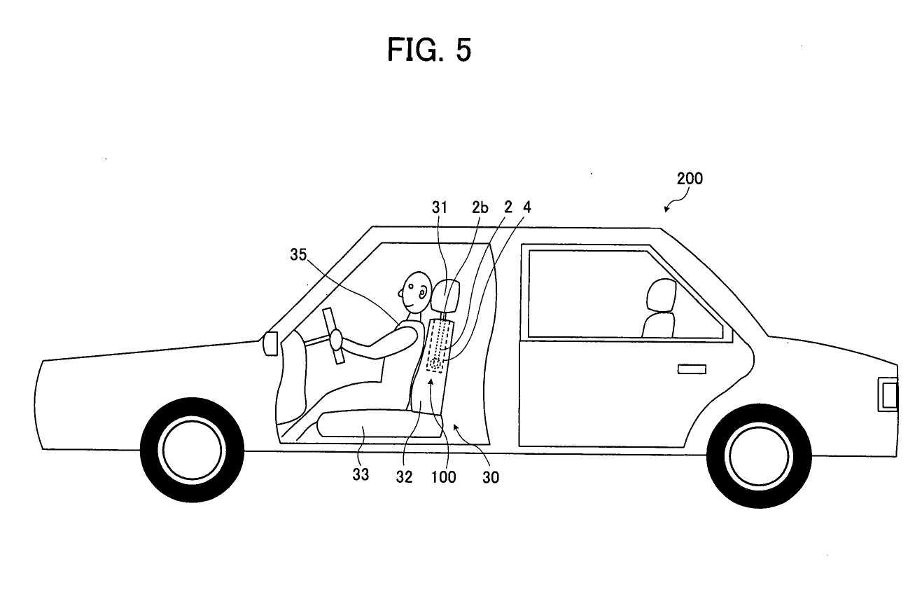

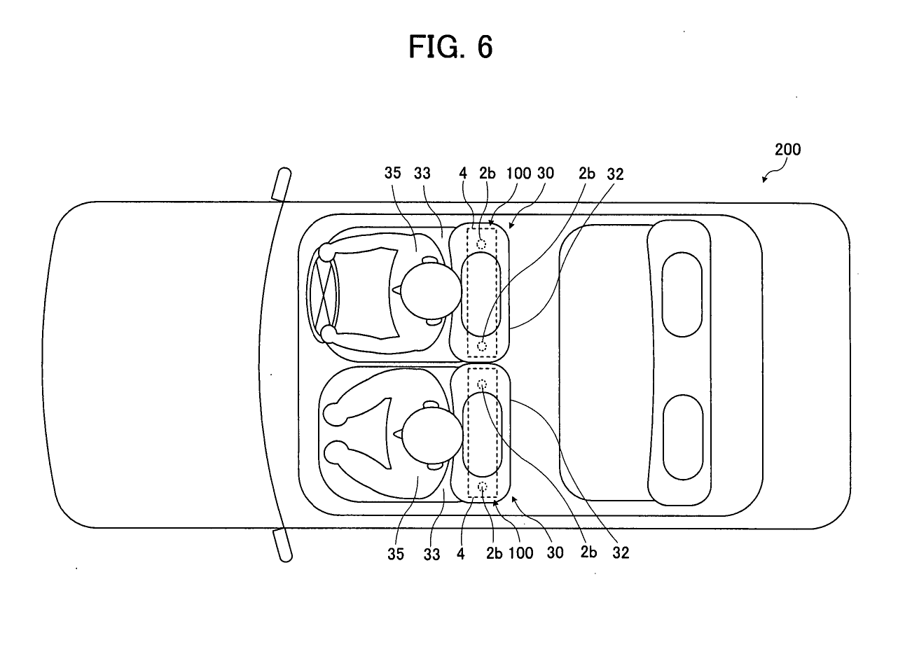

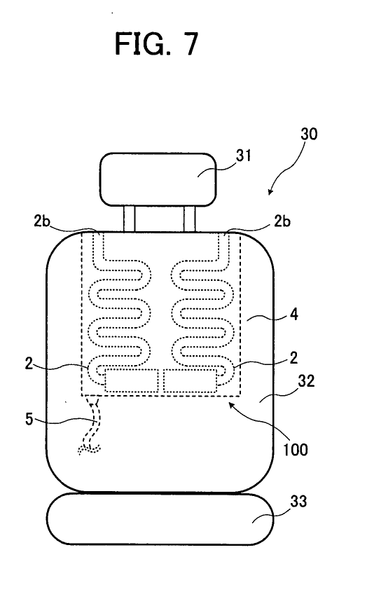

FIG. 5 to FIG. 7 show the state in which the speaker units 100 of the present invention are mounted to front seats 30 of a driver's seat and a front passenger's seat of a vehicle 200. FIG. 5 shows a side view of the mounting state, and FIG. 6 shows a plan view of the mounting state. FIG. 7 shows a state in which the speaker 100 is mounted inside a backrest 32 of the front seat 30. It is noted that, in FIG. 5 and FIG. 6, a front door and a roof part of the vehicle 200 are omitted from the illustration so that the state in which the speaker units 100 are mounted in the front seats 30 can be clearly shown.

The front seat 30 of the vehicle 200 includes a head support part 31, the backrest 32 and a seat part 33, and the speaker 100 of the present invention is mounted inside the backrest 32 as shown in FIG. 5 to FIG. 7. In this case, the speaker 100 is mounted inside the backrest 32 in the state in which an upper surface 4c of the casing 4 of the speaker unit 100, which is provided with the open end 2b of each of the acoustic tubes 2, i.e., a sound emitting surface, is exposed from a top surface of the backrest. As a result, the open end 2b of each of the acoustic tubes 2 provided on the sound emitting surface of the speaker unit 100, i.e., the upper surface 4c of the casing 4, is disposed at a position in the vicinity of both ears of the seated person 35.

Since the open end 2b of each of the acoustic tubes 2 is disposed at the position in the vicinity of both ears of the seated person 35 in this way and low-frequency sound can be reproduced to the vicinity of both the ears of the seated person, the output sound pressure level of the drive speaker 3 is not needed so much. Therefore, the compact drive speaker 3 with the small bore diameter can be applied to the speaker unit 100. Accordingly, the speaker 100 itself can be made compact and light. It is experimentally proved in the scientific essays and the like that low-frequency sound reproduction to ears does not make listeners auditorily uncomfortable.

The speaker 100 of the present invention is designed to be mounted inside the backrest 32 of the seat 30. Therefore, it is not necessary to take the trouble to ensure a place for providing the speaker 100 in a periphery of the seat. Therefore, a narrow space inside the vehicle can be utilized effectively, and the speaker 100 of the present invention can be applied to a light car having a narrow in-vehicle space.

The speaker 100 can be selectively mounted to either one of the driver's seat or the front passenger's seat, and therefore the speaker 100 can be mounted only to the seat of the seated person 35 who prefers low-frequency sound reproduction, for example.

The open ends 2b of the acoustic tubes 2 are located in the vicinity of both ears of the seated person 35, and therefore the output sound pressure level of the drive speaker 3 required to the speaker 100 is not so high. Accordingly, even if the speaker units 100 mounted to both the driver's seat and the front passenger's seat are used at the same time, the low-frequency sound emitted from one of the speaker units 100 is hardly heard by the seated person 35 in the adjacent seat. Accordingly, the seated person 35 in each of the seats can listen to proper low-frequency sound.

### Second Embodiment

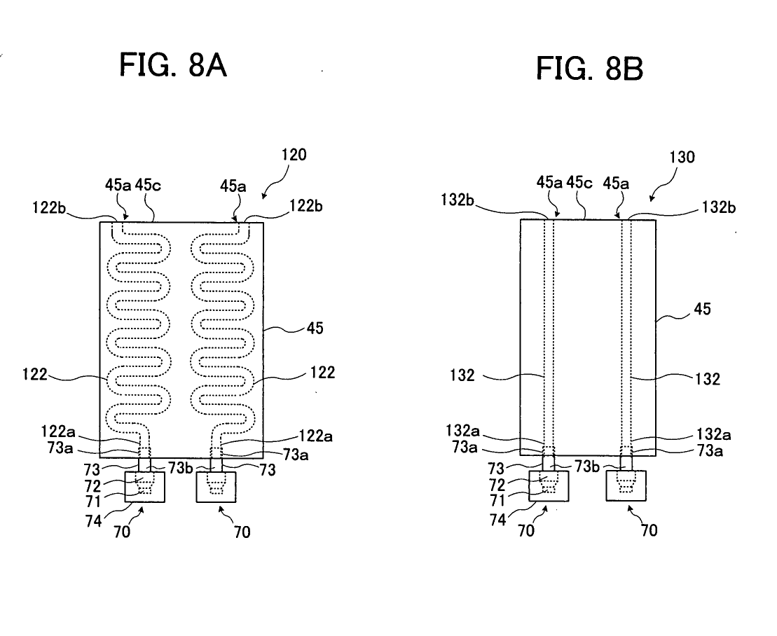

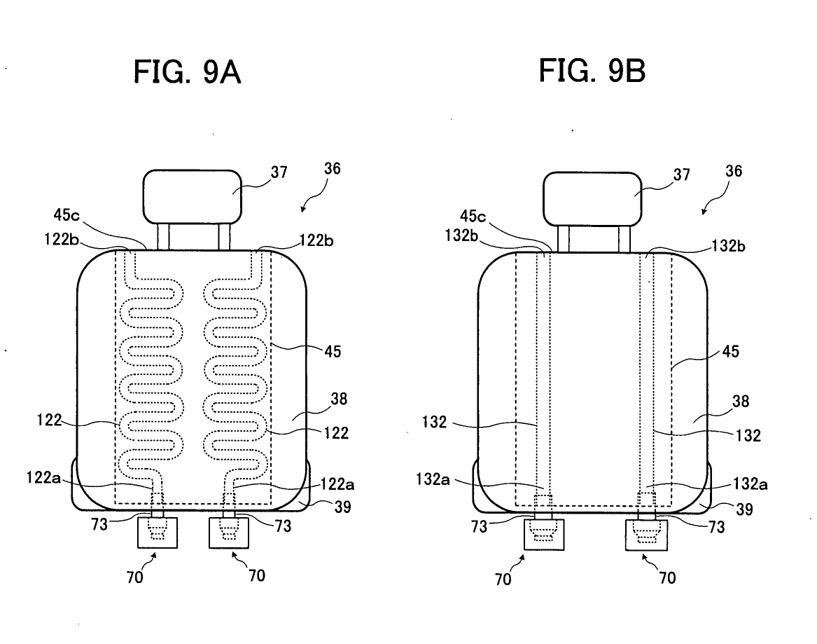

In the speaker 100 of the above-described first embodiment, the acoustic capacity portion 1 and the drive speaker 3 are housed inside the casing 4. However, in a second embodiment, a part of the acoustic tube, the acoustic capacity portion, the drive speaker and the like are provided outside the casing as an external unit, and are made freely attachable and detachable to and from the acoustic tube housed inside the casing. Thereby, it is made possible to replace the acoustic capacity portion and the drive speaker and to change the lowest resonance frequency of the speaker unit afterwards. The sound reproduction principle, the methods of supplying electric power and audio signals of the speaker unit in the second embodiment are approximately the same as the speaker 100 of the first embodiment, and therefore the explanation will be omitted in this point. Hereinafter, a speaker unit of the second embodiment will be explained with reference to FIG. 8 and FIG. 9.

FIGS. 8A and 8B schematically show constructions of the speaker units each provided with a part of the acoustic tube, the acoustic capacity portion and the drive speaker outside the casing. FIG. 8A shows a speaker unit 120 with curved acoustic tubes 122 housed in a casing 45. Meanwhile, FIG. 8B shows a speaker unit 130 with linear acoustic tubes 132 housed in the casing 45. The speaker units 120 and 130 differ only in the shapes of the respective acoustic tubes, and the other constituents are the same in both of them.

First, the construction of the speaker unit 120 will be described with reference to FIG. 8A.

The speaker unit 120 includes the casing 45 which houses a pair of curved acoustic tubes 122, and driving units 70 as the external unit.

Plural circular openings 45a are formed on an upper surface 45c of the casing 45. A position of each of the openings 45a corresponds to a position of one end portion, namely, an open end 122b of each of the acoustic tubes 122. As in the first embodiment, it is preferable to set a distance between the openings 45a at about the distance between both ears of an average human being. The driving unit 70 is detachably attached to the other end portion 122a of each of the acoustic tubes 122.

The driving unit 70 includes a drive speaker 71, an acoustic capacity portion 72, a casing 74 housing the drive speaker 71 and the acoustic capacity portion 72, and an external acoustic tube 73.

The drive speaker 71 is preferably a compact and light speaker suitable for reproduction of low-frequency sound. The drive speaker 71 has wiring not shown, and the wiring is connected to a sound source and the like. Therefore, the drive speaker 71 is supplied with electric power and audio signals from the sound source and the like through the wiring and is driven. The acoustic capacity portion 72 is connected to a sound emitting side of the drive speaker 71 and one end portion 73b of the external acoustic tube 73. The other end portion 73a of the external acoustic tube 73 is detachably attached to the other end portion 122a of the acoustic tube 122.

Next, a construction of the speaker unit 130 will be briefly explained with reference to FIG. 8B. The explanation of the same constituents as in the above-described speaker unit 120 will be omitted.

The speaker unit 130 includes the casing 45 housing a pair of linear acoustic tubes 132, and the driving units 70 as the external unit.

An open end 132b of the acoustic tube 132 is disposed at the position of the opening 45a formed on the upper surface 45c of the casing 45. The driving unit 70 is detachably attached to other end portion 132a of the acoustic tube 132.

Comparing the speaker unit 120 and the speaker unit 130 here, in the former, the curved acoustic tube 122 is housed inside the casing 45, while in the latter, the linear acoustic tube 132 is housed in the casing 45. Therefore, the length of the acoustic tube 132 in the speaker unit 130 is shorter than the length of the acoustic tube 122 in the speaker unit 120. By suitably changing the length of the acoustic tube in this manner, the lowest resonance frequency of the speaker unit can be freely changed.

FIGS. 9A and 9B show the states in which the speaker units 120 and 130 are respectively mounted inside the seats of the vehicle as examples. FIGS. 9A and 9B show rear views of seats 36 of the vehicle.

As shown in FIGS. 9A and 9B, the speaker units 120 and 130 are used in the state in which they are mounted inside the backrests of various kinds of seats, for example, backrests 38 of the seats 36 of the vehicle so that the upper surface 45c of the casing 45 on which each of the open ends 122b of the acoustic tube 122 and the open ends 132b of the acoustic tube 132 is located, i.e., the sound emitting surface, is exposed on a top surface of the backrest 38. More specifically, the open end 122b of the acoustic tube 122, and the open end 132b of the acoustic tube 132 are disposed on the top surface of the backrest 38, in other words, at the position in the vicinity of the head support part 37 as shown in FIGS. 9A and 9B. Accordingly, by driving the speaker unit 120 or 130, low-frequency sound can be reproduced to the position in the vicinity of both ears of the seated person through the open end 122b or 132b of the acoustic tube.

Meanwhile, the other end portion 122a of the acoustic tube 122 and the other end portion 132a of the acoustic tube 132 are respectively disposed at the lower positions of the backrests 38, in other words, the position in the vicinity of the seat part 39, as shown in FIGS. 9A and 9B. The placement of the driving unit 70 is not limited to such a position. Namely, if the acoustic tube 122 or 132 is attachable to and detachable from the driving unit 70, the driving unit 70 may be placed at any position with respect to the backrest. As understood with reference to FIGS. 9A and 9B, in such placement state, the driving unit 70 can be freely attached and detached to and from the acoustic tube 122 or 132.

Therefore, according to the speaker units 120 and 130, it is possible to mount a driving unit having different length of the acoustic tube to the acoustic tube 122 or 132 later as necessary. Therefore, the lowest resonance frequency of the speaker unit 120 or 130 can be freely changed afterwards. Therefore, the seated person can enjoy music or the like with output sound pressure being intensified in a desired low-frequency sound range. At the time when the drive speaker 71 inside the driving unit is out of order, it is possible to easily replace the drive speaker 71 by taking out the drive speaker 71 from the driving unit 70 or replace the driving unit 70 as a whole.

In the above-described example, the driving unit serving as the external unit is constructed by the drive speaker 71, the acoustic capacity portion 72 and the external acoustic tube 73, but the driving unit may be constructed to include only the drive speaker 71 and the acoustic capacity portion 72, without including the external acoustic tube 73. In this case, the frequency of the output sound can be changed by changing the capacity of the acoustic capacity portion 72.

A method of mounting the speaker units 120 and 130 of the second embodiment inside the seat of the vehicle is approximately the same as the method of mounting the above-described speaker 100 inside the seat of the vehicle in principle. However, since the driving unit 70 attachable to and detachable from the acoustic tube 122 or 132 exists in the speaker unit 120 or 130 of the second embodiment, it is necessary to form an opening in the portion of the backrest of the seat, which corresponds to the position of the other end portion 122a or 132a of the acoustic tube, for example.

### Other Application Examples of the Speaker Unit

Next, other application examples of the speaker unit of the present invention will be described. The speaker unit of the present invention is used in the state in which it is mounted inside various kinds of seats of a vehicle, a personal computer, a beauty parlor and the like. The examples in which the speaker 100 of the first embodiment of the present invention is applied to the chair for a personal computer, the chair of a beauty parlor and the like will be described. It is noted that the speaker units 120 and 130 of the second embodiment are also applicable to these chairs.

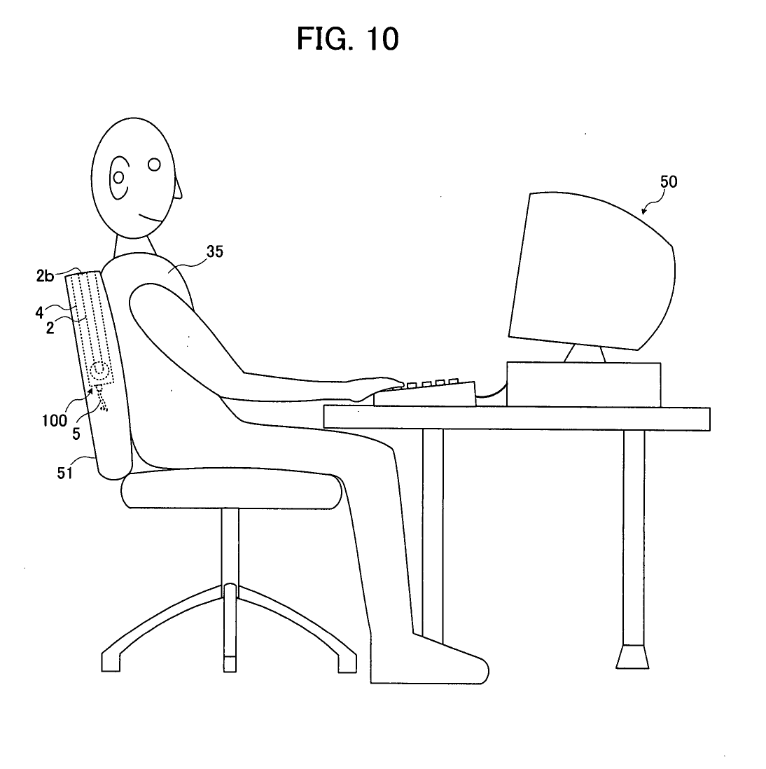

FIG. 10 shows a side view of a state in which the speaker 100 is mounted inside the backrest of a chair 51 for a personal computer 50 based on the above-described method. In this example, the open ends 2b of the respective acoustic tubes 2 are also reliably disposed near both ears of the seated person 35. In this example, a surround system is constructed by a speaker attached to the personal computer 50 and the speaker 100 of the present invention. Accordingly, the seated person 35 can enjoy DVDs (Digital Video Disc) and games with the sound having realism by such a surround system. If the speaker unit 120 or 130 of the second embodiment is applied to the chair 51 for the personal computer 50, the lowest resonance frequency can be changed afterwards, and therefore the seated person 35 can enjoy DVDs and games with a desired low-frequency sound sufficiently reproduced.

The speaker 100 is mounted inside the backrest of the chair 51 for the personal computer 50, and therefore the speaker 100 itself does not become an interference, either in this example.

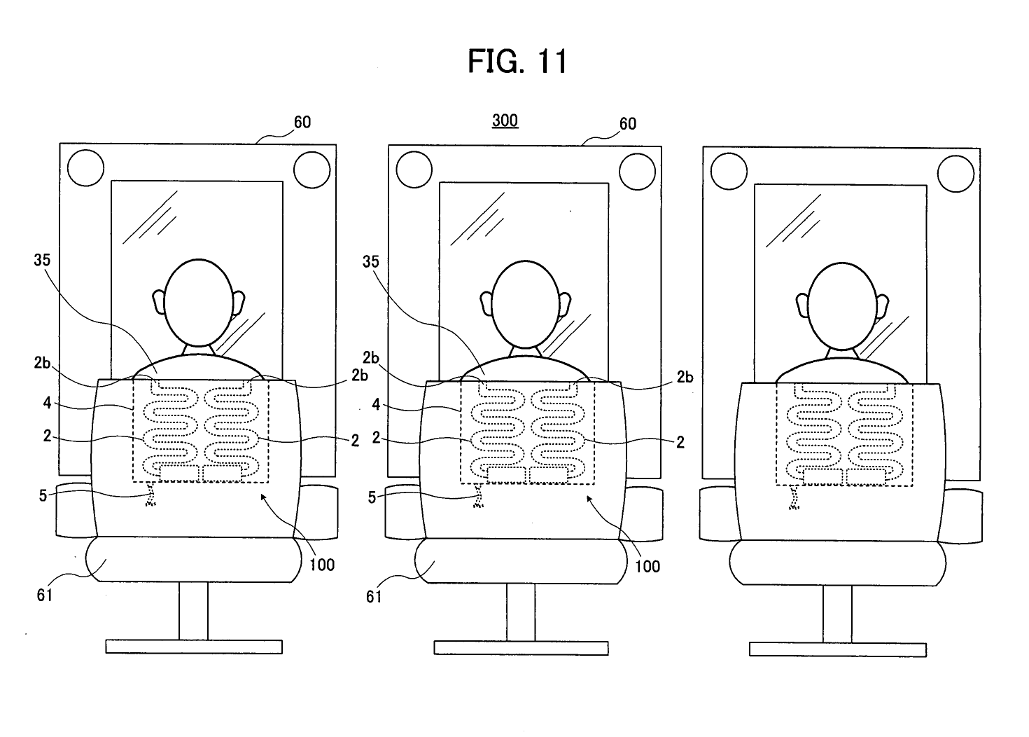

Next, FIG. 11 shows the state in which the speaker unit 100 is mounted inside the backrest of a chair 61 of a beauty parlor 300 according to the above-described same method, as a rear view. As shown in FIG. 11, the seated person 35 is seated in the chair 61 facing to a dressing table 60, and the speaker 100 is mounted inside the backrest of the chair 61. In this case, the open ends 2b of the respective acoustic tubes 2 are reliably disposed near both ears of the seated person 35. Accordingly, the speaker 100 is driven while the seated person 35 is having a haircut or having his or her hair permanently waved, whereby the seated person 35 can spend such a time comfortably.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-390599 filed on Nov. 20, 2003 including the specification, claims, drawings and summary is incorporated herein by reference in its entirety.

1. A speaker unit for a seat, comprising:
a speaker device comprising a pair of acoustic tubes; and
a casing which houses at least a part of said speaker device and is housed inside a seat,
wherein one end of each of said acoustic tubes is opened to an outside in a sound emitting surface of said casing which becomes a top surface and is exposed to the outside of the seat when said casing is housed inside the seat.

2. The speaker unit for the seat according to claim 1, wherein said casing houses a whole of said speaker device.

3. The speaker unit for the seat according to claim 1, wherein said casing houses only said acoustic tubes, wherein said speaker device further comprises external units each having an acoustic capacity portion and a drive speaker, and wherein the external units are detachably attached to the other ends of said acoustic tubes housed inside said casing at a position of an outside of the seat.

4. The speaker unit for the seat according to claim 1, wherein said casing houses only said acoustic tubes, wherein said speaker device further comprises external units each having an external acoustic tube, an acoustic capacity portion and a drive speaker, and wherein the external units are detachably attached to the other ends of said acoustic tubes housed inside said casing at a position of an outside of the seat.

5. The speaker unit for the seat according to claim 1, wherein each end portion of said pair of acoustic tubes is positioned in the vicinity of left and right ears of a seated person in the seat.

6. The speaker unit for the seat according to claim 5, wherein end portions of said pair of acoustic tubes opened to the outside are separated by a distance approximately equal to a distance between both ears of an average human being in the sound emitting surface of said casing.

7. A seat containing therein a speaker unit for the seat, the speaker unit comprising:
a speaker device comprising a pair of acoustic tubes; and
a casing which houses at least a part of said speaker device and is housed inside a seat,
wherein one end of each of said acoustic tubes is opened to an outside in a sound emitting surface of said casing which becomes a top surface and is exposed to the outside of the seat when said casing is housed inside the seat.
